(19) United States
(12) Patent Application Publication
(10) Pub. No.: US 2003/0127445 A1
(43) Pub. Date: Jul. 10, 2003

(54) Heater for heating waveguide and waveguide with heater

(75) Inventors: Takefumi Oguma, Tokyo (JP); Nobutaka Watanabe, Tokyo (JP)

Correspondence Address: McGinn & Gibb, PLLC, Suite 200, 8321 Old Courthouse Road, Vienna, VA, 22182, US

(73) Assignee: NEC Corporation, Tokyo (JP)

(21) Appl. No.: 10/295,878

(22) Filed: Nov. 18, 2002

(30) Foreign Application Priority Data
Nov. 19, 2001 (JP) 2001-352726

(51) Int. Cl. H05B 3/00

(52) U.S. Cl. 219/209; 219/543

(57) ABSTRACT

A heater includes (a) at least one heat generator which converts electric power to heat, (b) at least one substrate on which the heat generator is formed, and (c) at least one lead through which electric power is applied to the heat generator and which supports the substrate. For instance, the substrate has two opposite sides from each of which the lead extends, and the lead is comprised of a first portion outwardly extending from a side of the substrate, a second portion downwardly extending from an end of the first portion, and a third portion extending outwardly from an end of the second portion.

### BACKGROUND OF THE INVENTION

1. Field of the Invention

The invention relates to a heater for heating a circuit device including an electric circuit and/or an optical circuit, and further to a structure of mounting such a heater. The invention relates more particularly to a heater suitable for heating a circuit substrate such as a silicon substrate, a structure of mounting such a heater, and an optical waveguide device including such a heater.

2. Description of the Related Art

A communication network such as Internet is widely used. This requires a main network called a back born to transfer data at a higher rate and have a larger capacity. In order to enable a main network to have a larger capacity, a dense wavelength division multiplexing (DWDM) system draws attention. In a dense wavelength division multiplexing (DWDM) system, optical signals having different wavelengths from one another are multiplexed in a high density. A lot of waveguide devices are used in a dense wavelength division multiplexing (DWDM) system as devices for processing optical signals, such as an arrayed waveguide (AWG) used for synthesizing or dividing optical signals.

It would be necessary for such waveguide devices to stably operate in order to accomplish division of wavelength at a high density. To this end, it is necessary to keep a temperature at which waveguide devices operate constant. Accordingly, it is quite important to control a temperature of waveguide devices for their stable operation.

FIG. 1 illustrates a conventional heater device 501 used in a heater for heating a waveguide device.

The heater device 501 is comprised of a first lead 502, a second lead 508, a resistor 504 such as tungsten through which the first and second leads 502 and 503 are electrically connected to each other, and silicon rubber 505 in which the resistor 504 and a part of the first and second leads 502 and 503 are embedded.

The silicon rubber 505 has poor thermal conductivity. Hence, if the heater device 501 is designed to generate much heat, it would be necessary to form the resistor 504 to have a large diameter. As a result, the silicon rubber 505 surrounding the resistor 504 would have a larger volume, and hence, the heater device 501 would have a larger size.

FIG. 2 is a conventional heater 511 including the heater device 501 illustrated in FIG. 1, for heating a waveguide device.

The heater 511 includes a case 512 in which a waveguide device 513 such as an arrayed waveguide (AWG) is fixed in a predetermined position through a fixer (not illustrated)

The heater device 501 is fixedly adhered at a lower surface thereof to a substrate 515 through an adhesive 518, and is further fixedly adhered at an upper surface thereof to a lower surface of the waveguide device 513 through an adhesive 519.

The first and second leads 502 and 503 of the heater device 501 extend through a hole 521 formed through the substrate 515, and are electrically connected to a printed pattern (not illustrated) of the substrate 515.

The case 512 is mounted on a printed substrate 522. The printed pattern of the substrate 515 is electrically connected to the printed substrate 522 through a lead 514.

In operation of the conventional heater 511, electric power is applied to the heater device 510 through the substrate 515. Then, the heater device 510 converts electric power to heat, which is transferred to the waveguide device 513 through the silicon rubber 505 and the adhesive 519. Thus, the waveguide device 513 is heated.

If a circuit substrate mounted in a waveguide device to be heated, such as an arrayed waveguide, has to be accurately controlled with respect to a temperature thereof, it would be necessary for the heater 511 to have a thermal sensor for detecting a temperature of the circuit substrate, and a control circuit for controlling a temperature of the circuit substrate, based on the temperature detected by the thermal sensor, To this end, for instance, the heater 511 would have to further include a printed board on which such a thermal sensor and a control circuit as mentioned above are mounted.

FIG. 3 illustrates another conventional heater 541 including such a printed board 533, FIG. 3 is a view of the heater 541 viewed from a substrate 542 on which a heater device 517 is mounted. FIG. 4 is a side view of the heater 541.

With reference to FIG. 3, in the heater 541, the substrate 542 on which a heater device 517 is mounted is larger in size than a waveguide device 513. In order to enhance a thermal efficiency of the heater device 517, it would be necessary to prevent heat generated in the heater device 517 from conducting to parts other than the waveguide device 513. To this end, the substrate 542 on which the heater device 517 is mounted is adhered to the waveguide device 513, and the substrate 542 is fixed to the printed board 533 by means of leads 518 extending from the substrate 543 through the printed board 533.

In the heater 541, it would be possible to space the heater device 517 from the printed board 533 by designing the leads 518 to have a predetermined length.

However, since the heater 541 has to include the printed board 533 and the substrate 542, the heater 541 is accompanied with a problem of an increase in the number of parts and further in fabrication costs.

In addition, the heater 541 is accompanied further with a problem that since the leads 518 connecting the printed board 533 and the substrate 542 to each other have high thermal conductivity, heat generated in the heater device 517 conducts to the printed board 533 through the leads 518.

In order to solve these problems, Japanese Unexamined Patent Publication No. 8-110431 (A) has suggested an optic module including a first case, a heater device fixed on a lower surface of the first case, a waveguide device mounted on an upper surface of the first case, a second case surrounding the first case, and a non-metallic mount sandwiched between the first and second cases. The non-metallic mount prevents heat generated in the heater device from conducting to the second case, ensuring enhancement in a thermal efficiency. However, heat generated in the heater device conducts to the waveguide device through a thick wall of the first case. Hence, heat generated in the heater device is not always efficiently introduced into the waveguide device.

The above-mentioned problems in the conventional heater used for heating a waveguide device are not solved in heaters to be mounted on a printed board.

Japanese Unexamined Utility Model Publication No. 4-111182 (U) has suggested a ceramic heater comprised of a ceramic heater device including therein a resistor which converts electric power to heat, a lead electrically connected to the resistor and extending from the ceramic heater device, and a cylinder arranged between the resistor and the lead and covering the lead therewith. The cylinder is composed of ceramic having a coefficient of thermal expansion almost equal to that of the ceramic heater device.

Japanese Unexamined Utility Model Publication No. 5-11386 (U) has suggested a ceramic heater comprised of a ceramic substrate, a metallic layer formed on the ceramic substrate for generating heat, and a lead adhered to opposite ends of the metallic layer through an adhesive. The adhesive has a coefficient of thermal expansion almost equal to that of the ceramic substrate.

Japanese Unexamined Patent Publication No. 2000-306764 (A) has suggested an electronic component including an electronic part composed of ceramic and having therein an internal electrode a part of which is exposed to an end of the electronic part, an external electrode formed on the end of the electronic part for electrical contact with the internal electrode, and formed by coating and baking electrically conductive paste, and a metal plate adhered to a surface of the external electrode.

However, the above-mentioned problems remain unsolved even in those Publications.

### SUMMARY OF THE INVENTION

In view of the above-mentioned problems in the conventional heater, it is an object of the present invention to provide a heater for heating a waveguide device which heater provides a high thermal efficiency and can be fabricated with the reduced number of parts, ensuring reduction in fabrication costs.

It is also an object of the present invention to provide a structure of mounting such a heater as mentioned above.

It is further an object of the present invention to provide an optical waveguide device including the above-mentioned heater.

In one aspect of the present invention, there is provided a heater including (a) at least one heat generator which converts electric power to heat, (b) at least one substrate on which the heat generator is formed, and (c) at least one lead through which electric power is applied to the heat generator and which supports the substrate.

In the suggested heater, electric power is supplied to the heater generator through the lead for enabling the heater generator to generate heat, and in addition, the lead supports the substrate. Hence, the heater can have a simplified structure, and can be fabricated in reduced costs and smaller in size.

When the substrate has at least one pair of opposite sides from each of which the lead extends, the lead may be designed to have a proximal end at which the lead outwardly extends from a side of the substrate, and a distal end located far away from and below the proximal end.

When the substrate has two opposite sides from each of which the lead extends, the lead may be designed to be comprised of a first portion outwardly extending from a side of the substrate, a second portion downwardly extending from an end of the first portion, and a third portion extending outwardly from an end of the second portion.

By designing the lead to have the above-mentioned structure, the heater can be arranged above the substrate by means of the lead.

For instance, the lead may be designed to downwardly extend from a lower surface of the substrate.

For instance, the lead is composed of nickel alloy. Specifically, the lead may be composed of 42 alloy or covar.

The nickel alloy has superior electrical conductivity, but has poor thermal conductivity. Hence, it is preferable to compose the lead of nickel alloy.

For instance, the heat generator may be comprised of a pattern composed of a metal which converts electric power to heat and printed on a surface of the substrate.

The heater may include a plurality of substrates at least one of which includes the heat generator comprised of a pattern composed of a metal which converts electric power to heat and printed on a surface of the substrate.

As an alternative, the heater may include a plurality of substrates at least two of which includes the heat generator such that heat generators do not face each other, the heat generator being comprised of a pattern composed of a metal which converts electric power to heat and printed on a surface of the substrate.

When the heater is designed to include a, plurality of substrates at least two of which includes the heat generator, each of the substrates may be formed therethrough with two holes associated with two ends of the pattern, pins are inserted into the holes, the pins associated with one ends of the patterns are electrically connected to one another and further to one of the leads, and the pins associated with the other ends of the patterns are electrically connected to one another and further to one of the leads.

For instance, the substrate is composed of ceramics, glass or silicon.

Ceramics is an electrical insulator, and has a high thermal conductivity. In addition, it is possible to mount a heat generator on ceramics, since ceramics has high stiffness. Similarly, glass and silicon are both electrical insulators, and have a high thermal conductivity.

For instance, the substrate may be composed of ceramics nitride or ceramics oxide.

The heater may further include a thermal sensor which detects a temperature of the heat generator. For instance, the thermal sensor is mounted on a substrate other than a substrate including the heat generator.

By using the thermal sensor mounted on a substrate, a temperature of the heat generator can be detected with a higher accuracy than an accuracy obtained when a temperature of the heat generator is detected by means of a thermal sensor additionally externally provided to the heater. In addition, the heater including a thermal sensor mounted on a substrate can be fabricated smaller in size than a heater including a thermal sensor additionally externally provided thereto.

There is further provided a heater including (a) at least one heat generator which converts electric power to heat, (b) at least one substrate on which the heat generator is formed, and (c) a plurality of solder balls through which electric power is applied to the heat generator and which supports the substrate.

In the suggested heater, electric power is supplied to the heater generator through the solder balls for enabling the heater generator to generate heat, and in addition, the solder balls supports the substrate. Hence, the substrate can be firmly supported. In addition, an air layer formed between the substrate and a base above which the substrate is arranged through the solder balls enhances a thermal efficiency of the heater.

In another aspect of the present invention, there is provided a structure for mounting a heater, including (a) at least one heat generator which converts electric power to heat, (b) at least one substrate on which the heat generator is formed and on which an object to be heated is mounted, (c) a base substrate above which the substrate is arranged, and (d) at least one lead through which electric power is applied to the heat generator and which supports the substrate above the base substrate with a space therebetween.

In the suggested structure, the substrate is spaced away from the base substrate by means of the lead. A space between the substrate and the base substrate prevents heat from conducting to the base substrate, ensuring enhancement in a thermal efficiency and reduction in power consumption.

It is preferable that the space is in the range of 0.1 mm to 10 mm both inclusive.

The lead may be designed to downwardly extend from a lower surface of the substrate through a hole formed through the base substrate such that the lead is fixed in the hole.

The lead may be designed to downwardly extend from a lower surface of the substrate through a hole formed through the base substrate, and wherein the lead is inserted into a sleeve having a predetermined length, between the substrate and the base substrate.

The lead may be designed to downwardly extend from a lower surface of the substrate through a hole formed through the base substrate, the lead having a portion extending between the substrate and the base substrate, the portion having a predetermined length and a diameter greater than a diameter of the hole.

There is further provided a structure for mounting a heater, including (a) at least one heat generator which converts electric power to heat, (b) at least one substrate on which the heat generator is formed and on which an object to be heated is mounted, (c) a base substrate above which the substrate is arranged, and (d) a plurality of solder balls through which electric power is applied to the heat generator and which supports the substrate above the base substrate with a space therebetween.

In the suggested structure, the substrate is spaced away from the base substrate by means of the solder balls. A space between the substrate and the base substrate prevents heat from conducting to the base substrate, ensuring enhancement in a thermal efficiency and reduction in power consumption.

For instance, the object is an optical waveguide.

Since an optical waveguide can be adjusted with respect to a characteristic by heating, the heat generator may be used for heating an optical waveguide mounted on the substrate.

For instance, the object and the substrate may be fixedly adhered to each other.

In still another aspect of the present invention, there is provided an optical waveguide device including (a) at least one heat generator which converts electric power to heat, (b) at least one substrate on which the heat generator is formed, (c) a base substrate above which the substrate is arranged, (d) at least one lead through which electric power is applied to the heat generator and which supports the substrate above the base substrate with a space therebetween, and (e) an optical waveguide fixedly mounted on the substrate.

In the suggested optical waveguide device, electric power is supplied to the heater generator through the lead for enabling the heater generator to generate heat, and in addition, the lead supports the substrate. Hence, the optical waveguide device can have a simplified structure, and can be fabricated in reduced costs and smaller in size.

The substrate is spaced away from the base substrate by means of the lead. A space between the substrate and the base substrate prevents heat from conducting to the base substrate, ensuring enhancement in a thermal efficiency and reduction in power consumption.

The optical waveguide device may further include a thermal sensor which detects a temperature of the heat generator.

The thermal sensor may be mounted on a substrate other than a substrate including the heat generator, in which case, electric power is applied to the thermal sensor through the lead.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a plan view of a conventional heater device used for heating a waveguide device.

FIG. 2 is a cross-sectional view of a conventional heater including the heater device illustrated in FIG. 1.

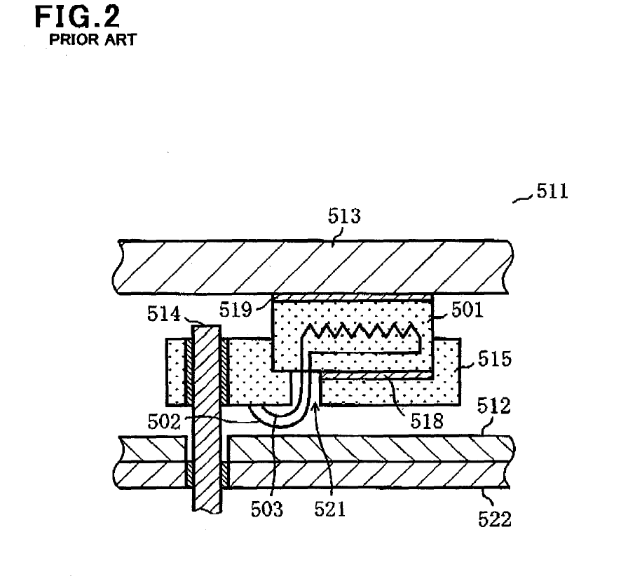

FIG. 3 is a plan view of another conventional heater including a printed board.

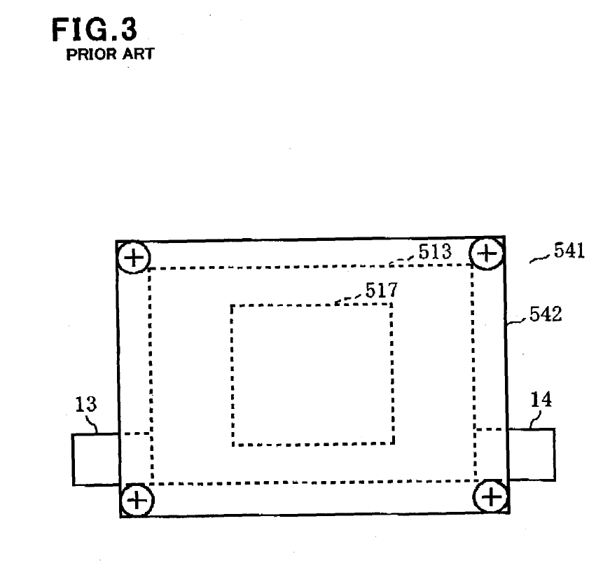

FIG. 4 is a side view of the heater illustrated in FIG. 3.

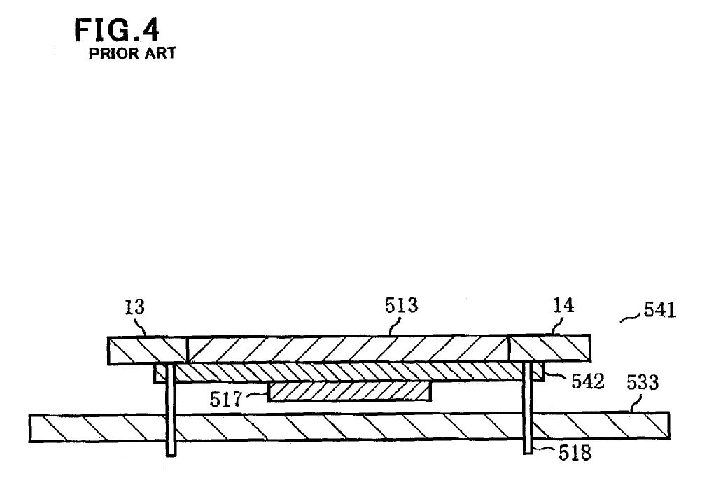

FIG. 5 is a plan view of a heater in accordance with the first embodiment of the present invention.

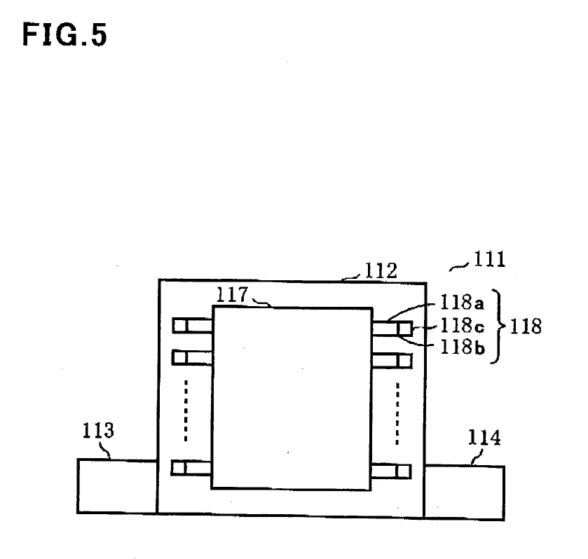

FIG. 6 is an exploded perspective view of a heater device in the heater in accordance with the first embodiment of the present invention.

FIG. 7 is a cross-sectional view of a heater including a printed board on which the heater device illustrated in FIG. 6 is mounted.

FIG. 8 is an exploded perspective view of a heater device in a heater in accordance with the second embodiment of the present invention.

FIG. 9 is a cross-sectional view of a heater device in a heater in accordance with the third embodiment of the present invention.

FIG. 10 is a cross-sectional view taken along the line X-X in FIG. 9.

FIG. 11 is a cross-sectional view of a heater device in a heater in accordance with the fourth embodiment of the present invention.

FIG. 12 is a plan view of a heater device used in the heater in accordance with the fourth embodiment of the present invention.

FIG. 13 is a cross-sectional view taken along the line XIII-XIII in FIG. 11.

FIG. 14 is a cross-sectional view of a heater device used in a heater in accordance with the fifth embodiment of the present invention.

FIG. 15 is a cross-sectional view of a heater device used in a heater in accordance with the sixth embodiment of the present invention.

### DESCRIPTION OF THE PREFERRED EMBODIMENTS

Preferred embodiments in accordance with the present invention will be explained hereinbelow with reference to drawings.

[First Embodiment]

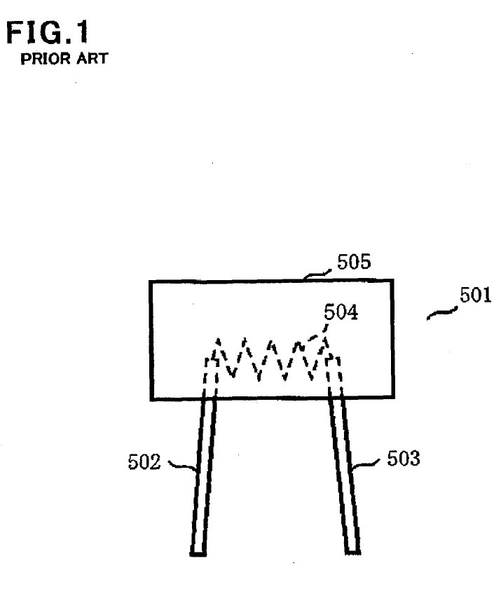

FIG. 1 is a partial plan view of a heater in accordance with the first embodiment of the present invention, Specifically, FIG. 1 illustrates a waveguide 111 in a heater 142 in accordance with the first embodiment.

The illustrated waveguide 111 is comprised of a heater device 117, a plurality of leads 118 extending from sides of the heater device 117, a waveguide device 112 on which the heater device 117 is mounted, a first optical fiber 113, and a second optical fiber 114.

The first and second optical fibers 113 and 114 are arranged at an end of the waveguide device 112, and are connected to waveguides (not illustrated).

The heater device 117 is fixedly adhered to the waveguide device 112 through an adhesive 134. The heater device 117 covers an area of the waveguide device 112 where a temperature has to be kept at a predetermined temperature.

The heater device 117 has a shape similar to an integrated circuit (IC) package, and opposite sides from which the leads 118 extend. The leads 118 are composed of metal having an electrical conductivity and a high thermal resistance. For instance, the leads 118 are composed of alloy 42.

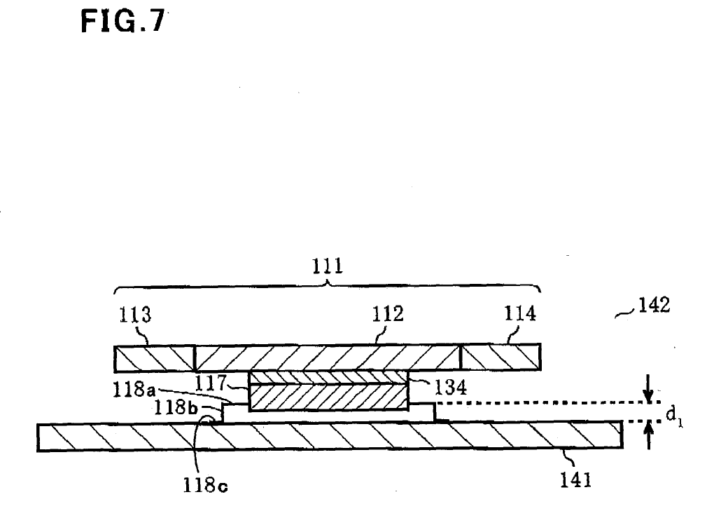

As best illustrated in FIG. 7, each of the leads 118 is comprised of a first portion 118a outwardly extending from a side of the heater device 117, a second portion 118b downwardly extending from an end of the first portion 118a, and a third portion 118c extending outwardly from an end of the second portion 118b.

In brief, each of the leads 118 is crank-shaped. However, it should be noted that each of the leads 118 may be designed to have any shape, unless it has a proximal end at which the lead 118 outwardly extends from a side of the heater device 117, and a distal end located far away from and below the proximal end.

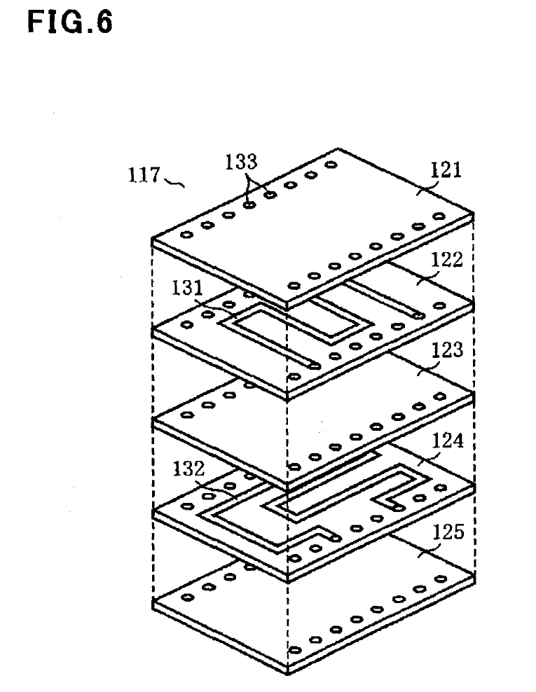

FIG. 6 is an exploded perspective view of the heater device 117 of the heater 111.

The heater device 117 is comprised of first to fifth ceramic substrates 121 to 125 layered one on another. Each of the first to fifth ceramic substrates 121 to 125 is composed of aluminum nitride or alumina.

A first heater pattern 131 is formed on a surface of the second ceramic substrate 122. Similarly, a second heater pattern 132 is formed on a surface of the fourth ceramic substrate 124. The first and second heater patterns 131 and 132 are formed by evaporating or printing tungsten (W) on surfaces of the second and fourth substrates 122 and 124.

Each of the first to fifth ceramic substrates 121 to 125 is formed in a line in the vicinity of opposite longitudinal edges thereof with apertures 133 in association with the leads 118.

Each of the first and second heater patterns 131 and 132 starts at one of the apertures 133 and terminates at another one of the apertures 133.

Pins (not illustrated) are inserted into the apertures 133 at which the first and second heater patterns 131 and 132 start and terminate. The pin inserted into the aperture 133 at which the first heater pattern 131 starts and the pin inserted into the aperture 133 at which the second heater pattern 132 starts are electrically connected to each other through a wire (not illustrated) or through solder. Similarly, the pin inserted into the aperture 133 at which the first heater pattern 131 terminates and the pin inserted into the aperture 133 at which the second heater pattern 132 terminates are electrically connected to each other through a wire (not illustrated) or through solder. The pins are electrically connected to the associated leads 118. Thus, electric power is supplied to the first and second heater patterns 131 and 132 through the associated leads 118. The first and second heater patterns 131 and 132 convert received electric power to heat. Thus, the heater device 117 generates heat.

As illustrated in FIG. 6, the first heater pattern 131 formed on the second ceramic substrate 122 and the second heater pattern 132 formed on the fourth ceramic substrate 124 are different in shape from each other. Accordingly, heat is generated in various areas in the heater device 117.

In the heater device 117, the second ceramic substrate 122 on which the first heater pattern 131 is formed is sandwiched between the first and third ceramic substrates 121 and 123 on both of which a heater pattern is not formed, and similarly, the fourth ceramic substrate 124 on which the second heater pattern 132 is formed is sandwiched between the third and fifth ceramic substrates 123 and 125 on both of which a heater pattern is not formed. This is for the purpose of enhancing electrical insulation of the first and second heater patterns 131 and 132.

However, as long as the first and second heater patterns 131 and 132 are formed only one of surfaces of the second and fourth ceramic substrates 122 and 124 as in the first embodiment, the third and fifth ceramic substrates 123 and 125 may be omitted from the heater device 117.

FIG. 7 is a cross-sectional view of the heater 142 including a printed board 141 on which the waveguide 111 is mounted.

As mentioned earlier, the heater device 117 is fixedly adhered to the waveguide device 112 through an adhesive 134 to cover an area of the waveguide device 112 where a temperature has to be kept at a predetermined temperature. Then, the leads 118 extending from sides of the heater device 117 are soldered to electrodes (not illustrated) of the printed board 141. Thus, the heater 142 is completed.

In accordance with the first embodiment, since the leads 118 are configured to be able to be mounted onto the printed board 141, it would be possible to automatically mount the waveguide 111 on the printed board 141, ensuring reduction in the number of fabrication steps of the heater 142.

A space d1 between a lower surface of the heater device 117 and an upper surface of the printed board 141 is defined as a length of the second portion 118b of the lead 118. The space d1 is set not equal to zero (0), but equal to a certain distance or more. As a result, an air layer is formed between a lower surface of the heater device 117 and an upper surface of the printed board 141. Since air has poor thermal conductivity, it would be possible to remarkably reduce heat diffused towards the printed board 141 from the heater device 117, which ensures remarkable reduction of power consumption of the heater device 117.

In the first embodiment, the space d1 is set equal to 0.2 mm. The space d1 may be set greater than 0.2 mm, but the heater 142 will be greater in size as the space d1 is set longer.

If the space d1 is set greater than a certain space, a convection is generated in the air layer formed between a lower surface of the heater device 117 and an upper surface of the printed board 141. Accordingly, the space d1 is preferably in the range of about 0.1 mm to about 10 mm both inclusive. By setting the space d1 in the range of about 0.1 mm to about 10 mm, when the waveguide device 112 is kept at about 80 degrees centigrade by the heater device 117, it would be possible to keep a temperature of a surface of the printed board 141 at about 30 to 40 degrees centigrade.

The heater device 117 in the first embodiment is designed to have a multi-layered structure comprised of the first to fifth ceramic substrates 121 to 125. Accordingly, the heater device 117 is more rigid and more unlikely to be deformed than the conventional heater device 501 illustrated in FIG. 1. As a result, it is possible for the heater device 117 to support the waveguide device 112 by adhering the waveguide device 112 thereto. That is, it is not necessary to stand pillars between the waveguide device 112 and the printed board 141 in order to fixedly position the waveguide device 112 relative to the printed board 141. Thus, the leads 118 can act as pillars to position the waveguide device 112 and the heater device 117 relative to each other.

As mentioned above, the leads 118 in the first embodiment act as pillars to hold the waveguide device 112 relative to the heater device 117, as well as a terminal through which electric power is supplied to the first and second heater patterns 131 and 132 and signals are transmitted to electrodes (not illustrated) of the heater device 117. This ensures significant reduction in the number of parts of the heater 142 and reduction in a size of the heater 142 and fabrication costs of the heater 142.

The first to fifth substrates 121 to 125 in the first embodiment are composed of ceramic. They may be composed of ceramic nitride or ceramic oxide. As an alternative, they may be composed of glass or silicon.

[Second Embodiment]

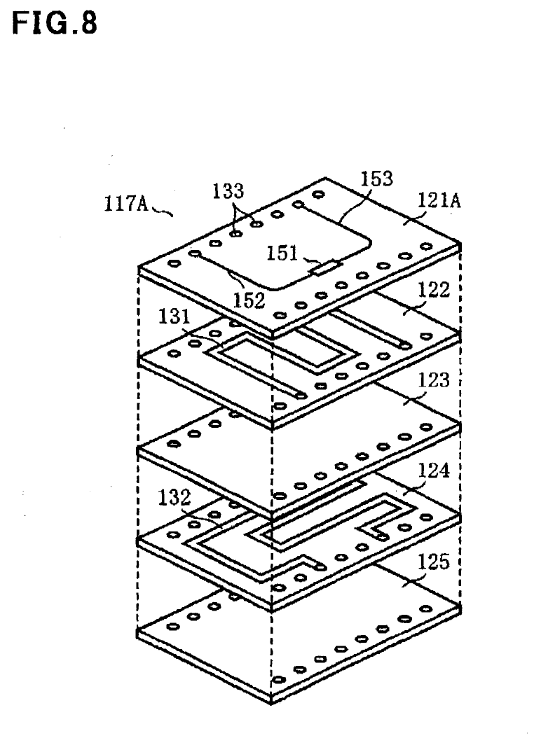

FIG. 8 is an exploded perspective view of a heater device 117A to be used in a heater in accordance with the second embodiment.

The heater in accordance with the second embodiment includes the heater device 117A in place of the heater device 117 illustrated in FIG. 6.

Parts or elements that correspond to those of the heater device 117 illustrated in FIG. 6 have been provided with the same reference numerals, and operate in the same manner as corresponding parts or elements in the first embodiment, unless explicitly explained hereinbelow.

The heater device 117A is designed to include a thermal sensor 151 mounted on a surface of the first ceramic substrate 121A, a first lead 152, and a second lead 153 both formed on a surface of the first ceramic substrate 121A.

The thermal sensor 151 detects a temperature of the waveguide device 112.

The first lead 152 is electrically connected at one end to the thermal sensor 141, and extends at the other end to an aperture 133 which does not correspond to the apertures 133 at which the first and second heater patterns 131 and 132 start or terminate. Similarly, the second lead 153 is electrically connected at one end to the thermal sensor 141, and extends at the other end to an aperture 133 which does not correspond to the apertures 133 at which the first and second heater patterns 131 and 132 start or terminate.

The thermal sensor 151 may be comprised, for instance, of a heat-generator pattern which varies its resistance in dependence on a temperature thereof,

The heater device 117A is adhered at a surface of the first ceramic substrate 121A to the waveguide device 112 through the adhesive 134, as illustrated in FIG. 7.

Electric power is supplied to a heater including the heater device 117A through some of the leads 118, and to the thermal sensor 151 through the other of the leads 118.

It should be noted that it is not always necessary to mount the thermal sensor 151 in the heater device 117A. For instance, the thermal sensor 151 may be mounted on a lower surface of the fifth ceramic substrate 125 facing the printed board 141.

[Third Embodiment]

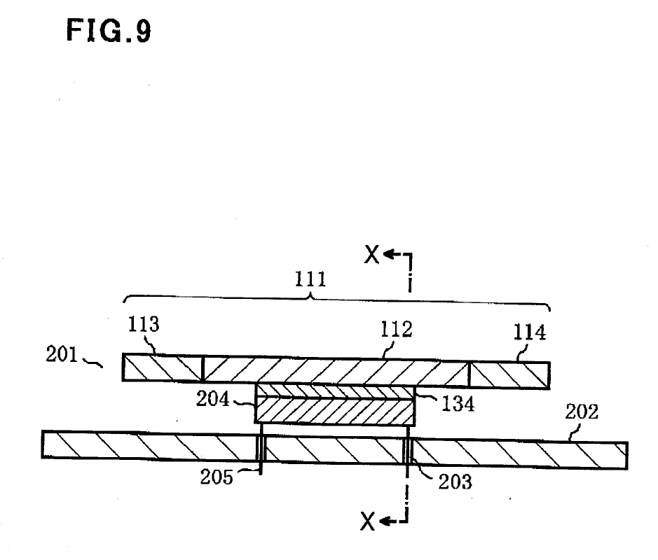

FIG. 9 is a cross-sectional view of a heater 201 in accordance with the third embodiment of the present invention.

Parts or elements that correspond to those of the heater 142 illustrated in FIG. 7 have been provided with the same reference numerals, and operate in the same manner as corresponding parts or elements in the first embodiment, unless explicitly explained hereinbelow.

The heater 201 in accordance with the third embodiment includes a printed board 202 which is formed therethrough with a plurality of through-holes 203. The through-holes 203 are arranged in two lines parallel to each other.

In the third embodiment, a plurality of leads 205 extends downwardly from a lower surface of a heater device 204 corresponding to the heater device 117 in the first embodiment. The leads 205 are inserted into the through-holes 203, and fixed inside the through-holes 203 by being soldered in the through-holes 203, for instance.

The heater device 204 has the same structure as that of the heater device 117 in the first embodiment, but the leads 205 extend from the heater device 204 in a different manner from the leads 118 extending from the heater device 117 in the first embodiment.

Similarly to the heater 142 in accordance with the first embodiment, illustrated in FIG. 7, the waveguide device 112 is adhered to a first ceramic substrate of the heater device 204 through the adhesive 134.

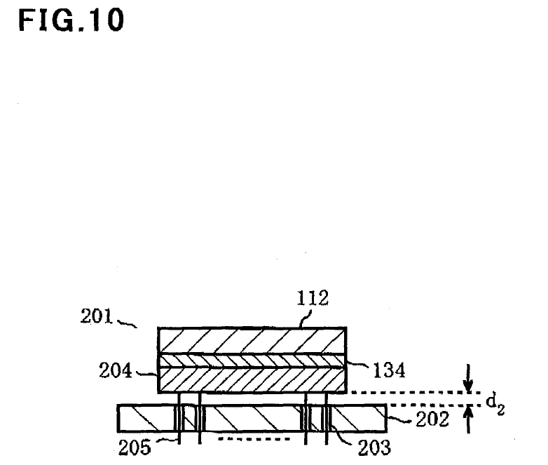

FIG. 10 is a cross-sectional view taken along the line X-X in FIG. 9.

As is understood in view of FIGS. 9 and 10, the heater device 204 is a rectangular parallelepiped having a lower surface from which the leads 205 extend downwardly in two lines spaced away from each other. FIG. 10 illustrates only one of the two lines of the leads 205. The leads 205 define a dual inline package (DIP) as a whole. Herein, a dual inline package (DIP) is one of terminal structures used in IC packets, and generally has terminals extending in two rows along two opposite longitudinal sides of a package.

The through-holes 203 are formed at the same pitch as a pitch between the adjacent leads 205. The leads 205 extending from the heater device 204 are inserted into the associated through-holes 203, and fixed in the through-holes 203 by being soldered therein.

In the third embodiment, since the leads 205 are not bent unlike the leads 118 in the first embodiment, a space d2 between a lower surface of the heater device 204 and the printed board 202 can be controlled to a desired space when the heater device 204 is mounted onto the printed board 202 by controlling a degree of insertion of the leads 205 into the through-holes 203.

In order to control the space d2 between the heater device 204 and the printed board 202, a sleeve may be used, if necessary. Before mounting the heater device 204 onto the printed board 202, each of the leads 205 is inserted into a sleeve having a predetermined length, and then, the leads 205 is soldered in the through-holes 203. As a result, the space d2 is defined as a length of the sleeve.

In place of the use of the sleeve, each of the leads 205 may be designed to have a diameter greater than a designed diameter of the through-hole 203, at a portion closer to the heater device 204, in which case, the rest of the through-hole 203 has a designed diameter. Assuming that the a portion having a diameter greater than a diameter of the through-hole 203 has a length L, the space d2 between the heater device 204 and the printed board 202 is equal to the length L.

The waveguide device 112 may be adhered to the heater device 204 through the adhesive 134 in advance of mounting the heater device 204 onto the printed board 202, or the waveguide device 112 may be adhered to the heater device 204 through the adhesive 134 after the heater device 204 has been mounted onto the printed board 202.

[Fourth Embodiment]

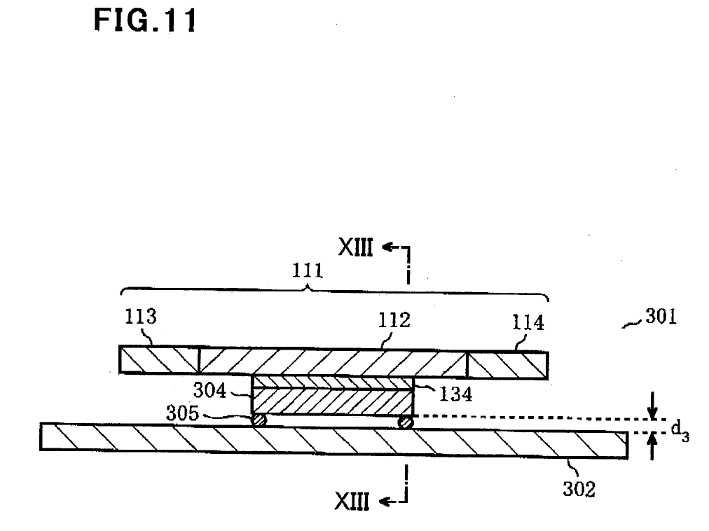

FIG. 11 is a cross-sectional view of a heater 301 in accordance with the fourth embodiment.

Parts or elements that correspond to those of the heater 142 illustrated in FIG. 7 have been provided with the same reference numerals, and operate in the same manner as corresponding parts or elements in the first embodiment, unless explicitly explained hereinbelow.

Whereas the heater device 117 is supported above the printed board 141 by means of the leads 118 in the first embodiment, a heater device 304 is supported above a printed board 302 by means of solder balls 305 in the fourth embodiment. Specifically, the solder balls 305 are sandwiched between electrical patterns (not illustrated) of the printed board 302 and a lower surface of the heater device 304.

In the fourth embodiment, a space d3 between a lower surface of the heater device 304 and an upper surface of the printed board 302 is set in the range of 0.2 to 0.3 mm both inclusive, though the space d3 is dependent on a diameter of the solder balls 305.

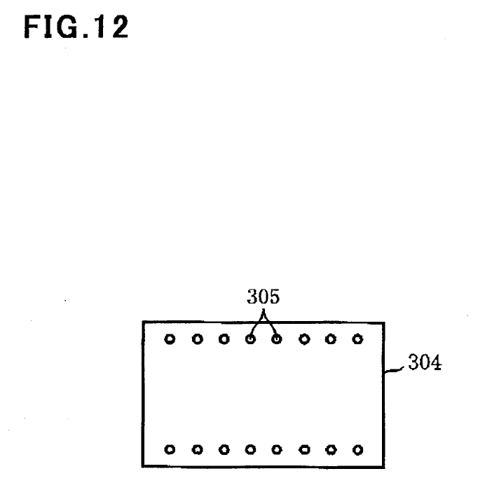

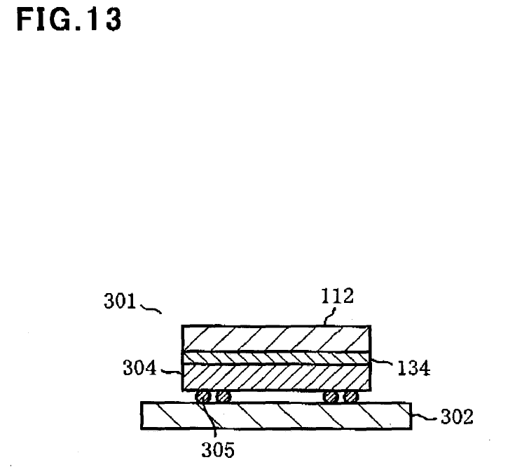

FIG. 12 is a plan view of the heater device 304. FIG. 12 illustrates a surface of the heater device 304 to which the printed board 302 is adhered. FIG. 13 is a cross-sectional view taken along the line XIII-XIII in FIG. 11.

As illustrated in FIGS. 11 and 13, a line of the solder balls 305 is arranged along each of opposite longitudinal edges of the heater device 304.

The printed board 302 is formed with solder paste by screen-printing on the electrical patterns thereof. When the heater device 304 is mounted onto the printed board 302, the solder balls 305 and the solder paste making contact with the solder balls 305 are both molten by heat generated in a reflow process, and resultingly, make electrical contact with each other.

Though the heaters 142, 201 and 301 in the above-mentioned first to fourth embodiments are explained as heaters used for controlling a temperature of the waveguide device 112, they may be used for controlling a temperature of other circuits to be mounted on a printed board.

The heater 142 is mounted above the printed board 141 by means of the flip-flop type leads 118 in the first embodiment, the heater 201 is mounted above the printed board 202 by means of the DIP type leads 205 in the second embodiment, and the heater 304 is mounted above the printed board 302 by means of the solder balls 305 in the third embodiment.

However, it should be noted that a heater may be mounted above a printed board by other means than the above-mentioned ones. For instance, a heater or a package of a heater is designed to have butterfly type terminals through which a heater or a package of a heater is mounted onto a printed board, in which case, leads are designed to extend from a package horizontally of a surface of a printed board, and the leads are soldered to and hence electrically connected to an electrical pattern or a terminal of a part mounted on a printed board.

If the part mounted on a printed board is electrically connected to the leads at a height from the printed board, an air layer would be formed between the part and the printed board. The air layer would act as a thermal insulator, ensuring sufficient thermal insulating between a heater and the printed board.

If such air layer is not formed, since a heater makes direct contact with a printed board, heat would conduct to a printed board to some degree at a portion at which the heater makes contact with the printed board. However, even so, the heater could have an advantage of having a simplified structure in comparison with a conventional heater.

In the above-mentioned first to fourth embodiments, the heater patterns 131 and 132 in the form of a film are arranged on a ceramic substrate. As an alternative, a heat generator may be embedded into a recess or a groove formed at a surface of a ceramic substrate. Similarly, the thermal sensor 151 may be embedded into a recess or a groove formed at a surface of a ceramic substrate, in place of being mounted on a ceramic substrate.

The first to fifth substrates 121 to 125 are composed of ceramics in the first to fourth embodiments. However, they may be composed of an electrical insulator other than ceramics, unless it has some resistance to heat. For instance, they may be composed of glass or mica.

[Fifth Embodiment]

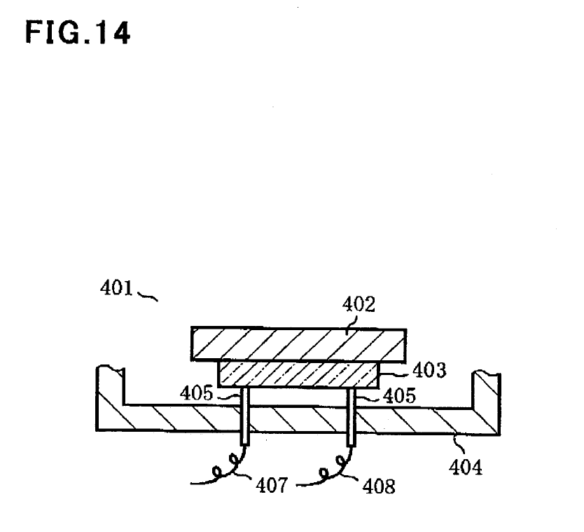

FIG. 14 is a cross-sectional view of a heater 401 in accordance with the fifth embodiment of the present invention.

The illustrated heater 401 is comprised of a heater device 403, and a plurality of leads 405 extending downwardly from a lower surface of the heater device 403.

The heater device 403 is fixedly adhered at its upper surface to a circuit board 402 to be heated, through an adhesive (not illustrated). The heater device 403 is accommodated in a case 404 (partially illustrated in FIG. 14) composed of ceramics. The leads 405 extend outwardly of the case 404 through a wall of the case 404.

Power-feeding wires 407 and 408 are soldered at one ends to ends of the leads 405 outside the case 404, and electrically connected at the other ends to a printed board or a circuit device (both not illustrated).

In the fifth embodiment, the leads 405 are fixed to the case by means of an adhesive, for instance. Similarly to the leads 118 in the first embodiment, electric power is supplied to the heater device 403 through the leads 405, and the leads 405 act as pillars for positionally fixing the heater device 403.

The case 404 is composed of an electrically insulating material in the fifth embodiment. When the case 404 is composed of an electrically conductive material, it would be necessary to apply electrical insulation to an outer surface of the leads 405, or insert each of the leads 405 into an electrically insulating sleeves.

[Sixth Embodiment]

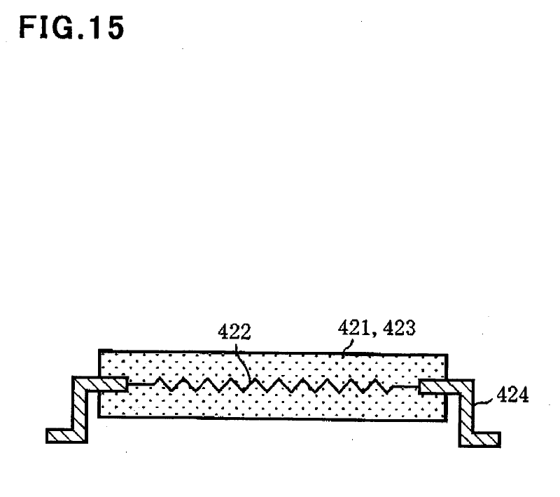

FIG. 15 is a cross-sectional view of a heater device 421 used in a heater in accordance with the sixth embodiment.

The heater devices 117, 117A, 204, 304 and 403 in the above-mentioned first to fifth embodiments are designed to have multi-layered insulating substrates in which electrical resistors are sandwiched. In contrast, the heater device 421 in the sixth embodiment is comprised of a resistor 422 composed of tungsten, for instance, a mold 423 composed of an electrically insulating material and including the resistor 422 molded therein, and leads 424 electrically connected to the resistor 422 at opposite ends.

Each of the leads 424 has the same structure as that of the lead 118 in the first embodiment. The heater device 421 is soldered to a printed board (not illustrated).

In the sixth embodiment, a circuit board to be heated is adhered to an upper surface of the mold 423. Though the heater device 421 is supported above a printed board (not illustrated in FIG. 15) by means of the leads 424, the heater device 421 may be fixed above a printed board by means of the leads 405 illustrated in FIG. 14, for instance. As an alternative, the heater device 421 may be fixed above a printed board by means of the solder balls 305 illustrated in FIG. 11.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-352726 filed on Nov. 19, 2001 including specification, claims, drawings and summary is incorporated herein by reference in its entirety.

What is claimed is:

1. A heater including:
(a) at least one heat generator which converts electric power to heat;
(b) at least one substrate on which said heat generator is formed; and
(c) at least one lead through which electric power is applied to said heat generator and which supports said substrate.

2. The heater as set forth in claim 1, wherein said substrate has at least one pair of opposite sides from each of which said lead extends, and wherein said lead has a proximal end at which said lead outwardly extends from a side of said substrate, and a distal end located far away from and below said proximal end.

3. The heater as set forth in claim 1, wherein said substrate has two opposite sides from each of which said lead extends, and wherein said lead is comprised of a first portion outwardly extending from a side of said substrate, a second portion downwardly extending from an end of said first portion, and a third portion extending outwardly from an end of said second portion.

4. The heater as set forth in claim 1, wherein said lead downwardly extends from a lower surface of said substrate.

5. The heater as set forth in claim 1, wherein said lead is composed of nickel alloy.

6. The heater as set forth in claim 5, wherein said lead is composed of 42 alloy or covar.

7. The heater as set forth in claim 1, wherein said heat generator is comprised of a pattern composed of a metal which converts electric power to heat and printed on a surface of said substrate.

8. The heater as set forth in claim 1, wherein said heater includes a plurality of substrates at least one of which includes said heat generator comprised of a pattern composed of a metal which converts electric power to heat and printed on a surface of said substrate.

9. The heater as set forth in claim 1, wherein said heater includes a plurality of substrates at least two of which includes said heat generator such that heat generators do not face each other, said heat generator being comprised of a pattern composed of a metal which converts electric power to heat and printed on a surface of said substrate.

10. The heater as set forth in claim 9, wherein each of said substrates is formed therethrough with two holes associated with two ends of said pattern,
pins are inserted into said holes,
said pins associated with one ends of said patterns are electrically connected to one another and further to one of said leads, and
said pins associated with the other ends of said patterns are electrically connected to one another and further to one of said leads.

11. The heater as set forth in claim 1, wherein said substrate is composed of ceramics, glass or silicon.

12. The heater as set forth in claim 1, wherein said substrate is composed of ceramics nitride or ceramics oxide.

13. The heater as set forth in claim 1, further comprising a thermal sensor which detects a temperature of said heat generator.

14. The heater as set forth in claim 13, wherein said thermal sensor is mounted on a substrate other than a substrate including said heat generator.

15. A heater including:
(a) at least one heat generator which converts electric power to heat;
(b) at least one substrate on which said heat generator is formed; and
(c) a plurality of solder balls through which electric power is applied to said heat generator and which supports said substrate.

16. The heater as set forth in claim 15, wherein said substrate is composed of ceramics, glass or silicon.

17. The heater as set forth in claim 15, wherein said substrate is composed of ceramics nitride or ceramics oxide.

18. The heater as set forth in claim 15, further comprising a thermal sensor which detects a temperature of said heat generator.

19. The heater as set forth in claim 18, wherein said thermal sensor is mounted on a substrate other than a substrate including said heat generator.

20. A structure for mounting a heater, including:
(a) at least one heat generator which converts electric power to heat;
(b) at least one substrate on which said heat generator is formed and on which an object to be heated is mounted;
(c) a base substrate above which said substrate is arranged; and
(d) at least one lead through which electric power is applied to said heat generator and which supports said substrate above said base substrate with a space therebetween.

21. The structure as set forth in claim 20, wherein said space is in the range of 0.1 mm to 10 mm both inclusive.

22. The heater as set forth in claim 20, wherein said substrate has at least one pair of opposite sides from each of which said lead extends, and wherein said lead has a proximal end at which said lead outwardly extends from a side of said substrate, and a distal end located far away from and below said proximal end.

23. The heater as set forth in claim 20, wherein said substrate has two opposite sides from each of which said lead extends, and wherein said lead is comprised of a first portion outwardly extending from a side of said substrate, a second portion downwardly extending from an end of said first portion, and a third portion extending outwardly from an end of said second portion.

24. The structure as set forth in claim 20, wherein said lead downwardly extends from a lower surface of said substrate through a hole formed through said base substrate such that said lead is fixed in said hole.

25. The structure as set forth in claim 20, wherein said lead downwardly extends from a lower surface of said substrate through a hole formed through said base substrate, and wherein said lead is inserted into a sleeve having a predetermined length, between said substrate and said base substrate.

26. The structure as set forth in claim 20, wherein said lead downwardly extends from a lower surface of said substrate through a hole formed through said base substrate, said lead having a portion extending between said substrate and said base substrate, said portion having a predetermined length and a diameter greater than a diameter of said hole.

27. The structure as set forth in claim 20, wherein said lead is composed of nickel alloy.

28. The structure as set forth in claim 27, wherein said lead is composed of 42 alloy or covar.

29. The structure as set forth in claim 20, wherein said heat generator is comprised of a pattern composed of a metal which converts electric power to heat and printed on a surface of said substrate.

30. The structure as set forth in claim 20, wherein said heater includes a plurality of substrates at least one of which includes said heat generator comprised of a pattern composed of a metal which converts electric power to heat and printed on a surface of said substrate.

31. The structure as set forth in claim 20, wherein said heater includes a plurality of substrates at least two of which includes said heat generator such that heat generators do not face each other, said heat generator being comprised of a pattern composed of a metal which converts electric power to heat and printed on a surface of said substrate.

32. The structure as set forth in claim 31, wherein said lead is formed therethrough with two holes associated with two ends of said pattern,
pins are inserted into said holes,
said pins associated with one ends of said patterns are electrically connected to one another and further to a lead, and
said pins associated with the other ends of said patterns are electrically connected to one another and further to another lead.

33. The structure as set forth in claim 20, wherein said substrate is composed of ceramics, glass or silicon.

34. The structure as set forth in claim 20, wherein said substrate is composed of ceramics nitride or ceramics oxide.

35. The structure as set forth in claim 20, wherein said object is an optical waveguide.

36. The structure as set forth in claim 20, wherein said object and said substrate are fixedly adhered to each other.

37. The heater as set forth in claim 20, further comprising a thermal sensor which detects a temperature of said heat generator.

38. The heater as set forth in claim 37, wherein said thermal sensor is mounted on a substrate other than a substrate including said heat generator.

39. A structure for mounting a heater, including:
(a) at least one heat generator which converts electric power to heat;
(b) at least one substrate on which said heat generator is formed and on which an object to be heated is mounted;
(c) a base substrate above which said substrate is arranged; and
(d) a plurality of solder balls through which electric power is applied to said heat generator and which supports said substrate above said base substrate with a space therebetween.

40. The structure as set forth in claim 39, wherein said substrate is composed of ceramics, glass or silicon.

41. The structure as set forth in claim 39, wherein said substrate is composed of ceramics nitride or ceramics oxide.

42. The structure as set forth in claim 39, wherein said object is an optical waveguide.

43. The structure as set forth in claim 39, wherein said object and said substrate are fixedly adhered to each other.

44. The heater as set forth in claim 39, further comprising a thermal sensor which detects a temperature of said heat generator.

45. The heater as set forth in claim 44, wherein said thermal sensor is mounted on a substrate other than a substrate including said heat generator.

46. An optical waveguide device comprising:
(a) at least one heat generator which converts electric power to heat;
(b) at least one substrate on which said heat generator is formed;
(c) a base substrate above which said substrate is arranged;
(d) at least one lead through which electric power is applied to said heat generator and which supports said substrate above said base substrate with a space therebetween; and
(e) an optical waveguide fixedly mounted on said substrate.

47. The optical waveguide device as set forth in claim 46, further comprising a thermal sensor which detects a temperature of said heat generator.

48. The optical waveguide device as set forth in claim 47, wherein said thermal sensor is mounted on a substrate other than a substrate including said heat generator, and wherein electric power is applied to said thermal sensor through said lead.

49. The optical waveguide device as set forth in claim 46, wherein said substrate has at least one pair of opposite sides from each of which said lead extends, and wherein said lead has a proximal end at which said lead outwardly extends from a side of said substrate, and a distal end located far away from and below said proximal end.

50. The optical waveguide device as set forth in claim 46, wherein said substrate has two opposite sides from each of which said lead extends, and wherein said lead is comprised of a first portion outwardly extending from a side of said substrate, a second portion downwardly extending from an end of said first portion, and a third portion extending outwardly from an end of said second portion.
